(19) United States
(12) Patent Application Publication
(10) Pub. No.: US 2024/0288699 A1
(43) Pub. Date: Aug. 29, 2024

(54) Electronic Devices with Nose Tracking Sensors

(71) Applicant: Apple Inc., Cupertino, CA (US)

(72) Inventors: Matin Seadat Beheshti, Sunnyvale, CA (US); Nicholas C Soldner, Los Altos, CA (US); Timo Birnschein, Redwood City, CA (US); Jia Tao, San Jose, CA (US)

(21) Appl. No.: 18/410,692

(22) Filed: Jan. 11, 2024

Related U.S. Application Data
(60) Provisional application No. 63/487,526, filed on Feb. 28, 2023.

(51) Int. Cl. G02B 27/01

(52) U.S. Cl. CPC G02B 27/0179; G02B 27/0172; G02B 2027/0134; G02B 2027/0178; G02B 2027/0187

(57) ABSTRACT

A head-mounted device may include optical assemblies for presenting images to a user. The optical assemblies may be movable relative to one another. The head-mounted device may include one or more nose tracking sensors for tracking a location of the nose relative to the optical assemblies and/or for detecting changes in the topographical surface of the nose as the optical assemblies are adjusted. The nose tracking sensor may be used to determine when the optical assemblies are too close to the user's nose or face. The nose tracking sensor may be mounted in the lens barrel, may be formed from gaze tracking components, may be formed from a dedicated sensor, or may be mounted outside of the lens barrel and may gather nose measurements through a nose bridge portion of a light seal.

This application claims the benefit of patent application No. 63/487,526, filed Feb. 28, 2023, which is hereby incorporated by reference herein in its entirety.

### FIELD

This relates generally to electronic devices and, more particularly, to electronic devices such as head-mounted devices.

### BACKGROUND

Electronic devices have components such as displays and lenses. It can be challenging to customize such devices for different users.

### SUMMARY

A head-mounted device may include optical assemblies for presenting images to a user. Each optical assembly may have a display and a lens through which an image from the display may be presented to a respective eye box. Motors may be used to adjust the spacing between the optical assemblies to accommodate different user interpupillary distances. Gaze trackers may be used to measure the eyes of a user to determine target positions for the optical assemblies.

The head-mounted device may include one or more nose tracking sensors for detecting a location of the nose and/or for measuring changes in the topographical surface of the nose as the optical assemblies are adjusted. Control circuitry in the head-mounted device may use information from the nose tracking sensors to determine when the optical assemblies are too close to the nose. The nose tracking sensor may include infrared light-emitting diodes and an infrared camera. The infrared camera may be configured to capture images of at least a portion of the nose while the nose is illuminated by nose illumination from the light-emitting diodes.

In some arrangements, nose tracking sensors may be mounted in the lens barrel of each optical assembly. The nose tracking sensor may share one or more components with a gaze tracking sensor in the lens barrel. For example, a gaze tracking sensor may include light-emitting diodes that emit both eye illumination for gaze tracking and nose illumination for nose tracking. The gaze tracking sensor may include a camera that detects reflected eye illumination from the eye and reflected nose illumination from the nose. The lens in the lens barrel may serve as a light guide that guides nose illumination laterally out of the lens and lens barrel toward the nose. In other configurations, a dedicated light guide may be used to guide nose illumination out of the lens barrel toward the nose. If desired, gaze tracking sensors and nose tracking sensors in the optical assembly may each have a dedicated pair of light emitters and light detectors that are mounted separately or in a common module.

In some arrangements, nose tracking sensors may be mounted outside of the optical assemblies and may, if desired, gather nose information through a nose bridge portion of a light seal. The nose bridge portion may have a reflective surface that is tracked by the nose tracking sensor. Light guides may guide nose illumination through the light seal, or nose tracking sensors may be mounted within the nose bridge portion of the light seal.

### BRIEF DESCRIPTION OF THE DRAWINGS

FIG. 1 is a diagram of an illustrative head-mounted device in accordance with some embodiments.

FIG. 2 is a top view of an illustrative head-mounted device having a movable optical assembly and a nose tracking sensor that emits nose illumination through an outer surface of a lens in the optical assembly in accordance with some embodiments.

FIG. 3 is a top view of an illustrative head-mounted device having a movable optical assembly and a nose tracking sensor that emits nose illumination through an edge surface of a lens in the optical assembly in accordance with some embodiments.

FIG. 4 is a top view of an illustrative head-mounted device having a movable optical assembly and a nose tracking sensor that emits nose illumination through a light guide in accordance with some embodiments.

FIG. 5 is a top view of an illustrative head-mounted device having a movable optical assembly and an integrated module that includes a gaze tracking sensor and a nose tracking sensor in accordance with some embodiments.

FIG. 6 is a top view of an illustrative head-mounted device having a movable optical assembly, a gaze tracking sensor, and a nose tracking sensor in accordance with some embodiments.

FIG. 7 is a rear view of an illustrative head-mounted device having movable optical assemblies and nose tracking sensors that detect a nose bridge portion of a light seal in accordance with some embodiments.

FIG. 8 is a rear view of an illustrative head-mounted device having movable optical assemblies and nose tracking sensors that operate through light guides in a light seal in accordance with some embodiments.

FIG. 9 is a rear view of an illustrative head-mounted device having movable optical assemblies and nose tracking sensors in a light seal in accordance with some embodiments.

### DETAILED DESCRIPTION

Electronic devices such as head-mounted devices may have displays for displaying images and lenses that are used in presenting the images to eye boxes for viewing by a user. Different users have different spacings between their eyes, which are sometimes referred to as interpupillary distances. To accommodate users with different interpupillary distances, a head-mounted device may be provided with movable optical assemblies.

Care must be taken when the positions of optical assemblies are adjusted relative to a user's face. Changes to the positions of optical assemblies, whether these changes are user-driven adjustments or system-driven adjustments, can lead to a decreased distance between the user's face and the optical assemblies in certain scenarios. Different users may be at different distances from the optical assemblies depending on the user's specific nose and face geometry.

To reduce the chance of compromised display performance and/or reduced field of view resulting from the optical assemblies being too close to the user's face or nose, a head-mounted device may include nose tracking sensors to track the position of the nose relative to the optical assemblies. The nose tracking sensor may be a three-dimensional camera, a visible or infrared image sensor, a proximity sensor (e.g., a distance sensor including one or more light-emitting diodes that emit light and one or more light sensors that detect the light after is reflects off of the user's nose), a capacitive sensor, an ultrasonic sensor, a strain gauge, and/or any other suitable sensor for detecting a distance to the nose, detecting a three-dimensional surface topography of the nose, and/or gathering other nose measurements.

Control circuitry in the head-mounted device may take suitable action when nose measurements from the nose tracking sensors indicate that one or both of the optical assemblies is too close to the nose. This may include, for example, outputting an alert or notification to the user, outputting instructions to the user to adjust the head-mounted device, preventing further movement of the optical assemblies, reversing a previous movement of the optical assemblies, and/or taking other actions.

In some arrangements, the nose tracking sensor may be mounted in the lens barrel of each optical assembly. The nose tracking sensor may illuminate the nose by emitting nose illumination through a lens in the optical assembly, by emitting nose illumination through a light guide that propagates the nose illumination out of the lens barrel, and/or by emitting nose illumination through a lens or hole on the side of the lens barrel. The nose tracking sensor may use light from a gaze tracking sensor to illuminate the nose. Some light from the gaze tracking sensor may be emitted through the lens to illuminate the user's eye for gaze tracking purposes, and some light from the gaze tracking sensor may be guided laterally out of the lens to illuminate the nose for nose tracking purposes. In other arrangements, the nose tracking sensor may have a dedicated light emitter and light detector that are mounted separately from the gaze tracking sensor or that are integrated into a common module with the gaze tracking sensor.

If desired, nose tracking sensors may be mounted outside of the lens barrels. For example, nose tracking sensors may gather nose information through a nose bridge portion of a light seal. The nose bridge portion may have a reflective surface that is tracked by the nose tracking sensor. Light guides may guide nose illumination through the light seal, or nose tracking sensors may be mounted within the nose bridge portion of the light seal.

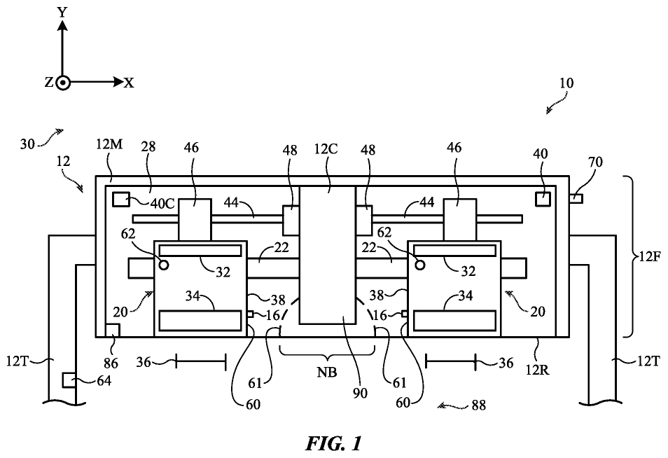

FIG. 1 is a schematic diagram of an illustrative electronic device of the type that may include movable optical assemblies (e.g., to accommodate different interpupillary distances). Device 10 of FIG. 1 may be a head-mounted device (e.g., goggles, glasses, a helmet, and/or other head-mounted device). In an illustrative configuration, device 10 is a head-mounted device such as a pair of goggles (sometimes referred to as virtual reality goggles, mixed reality goggles, augmented reality glasses, etc.).

As shown in the illustrative cross-sectional top view of device 10 of FIG. 1, device 10 may have a housing such as housing 12 (sometimes referred to as a head-mounted support structure, head-mounted housing, or head-mounted support). Housing 12 may include a front portion such as front portion 12F and a rear portion such as rear portion 12R. When device 10 is worn on the head of a user, rear portion 12R rests on the face of the user and helps block interior components from view while nose bridge portion NB of housing 12 rests on nose 90 of the user.

Main portion 12M of housing 12 may be attached to head strap 12T. Head strap 12T may be used to help mount main portion 12 on the head and face of a user. Main portion 12M may have a rigid shell formed from housing walls of polymer, glass, metal, and/or other materials. When housing 12 is being worn on the head of a user, the front of housing 12 may face outwardly away from the user, the rear of housing 12 (and rear portion 12R) may face toward the user. In this configuration, rear portion 12R may face the user's eyes located in eye boxes 36.

Device 10 may have electrical and optical components that are used in displaying images to eye boxes 36 when device 10 is being worn. These components may include left and right optical assemblies 20 (sometimes referred to as optical modules). Each optical assembly 20 may have an optical assembly support 38 (sometimes referred to as a lens barrel, optical module support, or support structure) and guide rails 22 along which optical assemblies 20 may slide to adjust optical-assembly-to-optical-assembly separation to accommodate different user interpupillary distances.

Each assembly 20 may have a display 32 that has an array of pixels for displaying images and a lens 34. Lens 34 may optionally have a removable vision correction lens for correcting user vision defects (e.g., refractive errors such as nearsightedness, farsightedness, and/or astigmatism). In each assembly 20, display 32 and lens 34 may be coupled to and supported by support 38. During operation, images displayed by displays 32 may be presented to eye boxes 36 through lenses 34 for viewing by the user.

Rear portion 12R may include flexible structures (e.g., a flexible polymer layer, a flexible fabric layer, etc.) so that portion 12R can stretch to accommodate movement of supports 38 toward and away from each other to accommodate different user interpupillary distances. In some illustrative arrangements, rear portion 12R includes a flexible fabric curtain with left and right openings for accommodating left and right optical assemblies 20. Housing 12 may include a light seal that extends around a perimeter of rear portion 12R (sometimes referred to as rear curtain 12R) and that is used to block light from reaching the viewing area where eye boxes 36 are located. The light seal may have a ring-shape or other loop shape and may be formed from foam, fabric, polymer, and/or other materials. The light seal of housing 12 may have a nose bridge portion NB formed from stretchy fabric that rests on the user's nose 90.

The walls of housing 12 may separate interior region 28 within device 10 from exterior region 30 surrounding device 10. In interior region 28, optical assemblies 20 may be mounted on guide rails 22. Guide rails 22 may be attached to central housing portion 12C. If desired, the outer ends of guide rails 22 may be unsupported (e.g., the outer end portions of rails 22 may not directly contact housing 12, so that these ends float in interior region 28 with respect to housing 12).

Device 10 may include control circuitry 40C and other components such as components 40. Control circuitry 40C may include storage, processing circuitry formed from one or more microprocessors, and/or other circuits. To support communications between device 10 and external equipment, control circuitry 40C may include wireless communications circuitry. The storage in control circuitry 40C may include nonvolatile memory (e.g., flash memory or other electrically-programmable-read-only memory configured to form a solid state drive), volatile memory (e.g., static or dynamic random-access-memory), etc. Processing circuitry in control circuitry 40C may be used to gather input from sensors and other input devices and may be used to control output devices. The processing circuitry in control circuitry 40C may be based on one or more microprocessors, microcontrollers, digital signal processors, baseband processors and other wireless communications circuits, power management units, audio chips, application specific integrated circuits, etc.

Components 40 may include sensors such as such as force sensors (e.g., strain gauges, capacitive force sensors, resistive force sensors, etc.), audio sensors such as microphones, touch and/or proximity sensors such as capacitive sensors, optical sensors such as optical sensors that emit and detect light, ultrasonic sensors, and/or other touch sensors and/or proximity sensors, monochromatic and color ambient light sensors, image sensors, sensors for detecting position, orientation, and/or motion (e.g., accelerometers, magnetic sensors such as compass sensors, gyroscopes, and/or sensors such as inertial measurement units that contain some or all of these sensors), radio-frequency sensors, depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, visual inertial odometry sensors, current sensors, voltage sensors, and/or other sensors. In some arrangements, devices 10 may use sensors to gather user input (e.g., button press input, touch input, etc.). Sensors may also be used in gathering environmental measurements, device motion measurements, temperature measurements, ambient light readings, etc.

Optical assemblies 20 may have gaze trackers 62 (sometimes referred to as gaze tracking sensors). Gaze trackers 62, which may operate through lenses 34, may include one or more light sources such as infrared light-emitting diodes that emit infrared light to illuminate the eyes of a user in eye boxes 36. Gaze trackers 62 also include infrared cameras for capturing images of the user's eyes and measuring reflections (glints) of infrared light from each of the infrared light sources. By processing these eye images, gaze trackers 62 may track the user's eyes and determine the point-of-gaze of the user. Gaze trackers 62 may also measure the locations of the user's eyes (e.g., the user's eye relief and the user's interpupillary distance).

To accommodate users with different interpupillary distances (eye-to-eye spacings), the spacing between the left and right optical assemblies 20 in device 10 can be adjusted (e.g., to match or nearly match the user's measured interpupillary distance). Device 10 may have left and right actuators (e.g., motors) such as motors 48. Each motor 48 may be used to rotate an elongated threaded shaft (screw) such as shaft 44. A nut 46 is provided on each shaft 44. The nut has threads that engage the threads on that shaft 44. When a shaft is rotated, the nut on the shaft is driven in the +X or −X direction (in accordance with whether the shaft is being rotated clockwise or counterclockwise). In turn, this moves the optical assembly 20 that is attached to the nut in the +X or −X direction along its optical assembly guide rail 22. Each assembly 20 (e.g., support 38) may have portions that receive one of guide rails 22 so that the assembly is guided along the guide rail. By controlling the activity of motors 48, the spacing between the left and right optical assemblies 20 of device 10 can be adjusted to accommodate the interpupillary distance of different users. For example, if a user has closely spaced eyes, assemblies 20 may be moved inwardly (toward each other and toward nose bridge portion NB of housing 12) and if a user has widely spaced eyes, assemblies 20 may be moved outwardly (away from each other).

When device 10 is being worn by a user, the user's head is located in region 88. In order to determine whether or not device 10 is being worn, the presence of the user's head may be detected using one or more sensors (e.g., gaze trackers 62, which may detect the presence of the eyes of the user in eye boxes 36, rear-facing sensors such as sensor 86 on main housing 12M, head-facing sensors mounted on strap 12T such as sensor 64, and/or other head presence sensors). These sensors may include cameras, light sensors (e.g., visible light or infrared sensors that measure when ambient light levels have dropped due to shadowing by the head of a user), proximity sensors (e.g., sensors that emit light such as infrared light and that measure corresponding reflected light from a user's head with an infrared light sensor, capacitive proximity sensors, ultrasonic acoustic proximity sensors, etc.), switches and/or other force-sensing sensors that detect head pressure when a user's head is present, and/or other head presence sensors.

When device 10 is being worn and a user's head is present in region 88, the nose 90 of the user will be present under nose bridge portion NB of housing 12. When optical assemblies 20 are moved toward each other so that assemblies 20 are spaced apart by an amount that matches or nearly matches the user's interpupillary distance, inner side surfaces 60 of support structures 38 in assemblies 20 will move toward opposing outer side surfaces 61 of the user's nose. With sufficient inward movement of assemblies 20, surfaces 60 may approach nose surfaces 61. As a result, an outward force on assemblies 20 is created by nose surfaces 61. To avoid compromised display performance or reduced field of view that might arise if the optical assemblies are too close to the user's face, device 10 may be provided with features to limit inward nose pressure (e.g., to limit inward force by assemblies 20).

With an illustrative embodiment, whenever device 10 is mounted on the head of a user, motors 48 may only be permitted to move optical assemblies 20 away from each other and not toward each other. This ensures that surfaces 60 will never move toward each other while the user's nose is present, so that the user's nose will never be pressed excessively by moving surfaces 60. Additionally or alternatively, the positions of optical assemblies 20 relative to nose 90 may be monitored using one or more nose tracking sensors in device 10 such as nose tracking sensors 16. Nose tracking sensor 16 may be configured to measure the location of the nose, the topography of the nose, the distance between the nose and optical assembly 20 (e.g., the distance between outer surface 60 of optical assembly 20 and outer surface 61 of the user's nose 90), the distance between nose 90 and a light seal on head-mounted device 10, the distance between optical assemblies 20 and the nose bridge portion NB of the light seal, and/or other information about nose 90 to avoid being too close to optical assemblies 20.

Nose tracking sensors 16 may be formed from depth sensors (e.g., structured light depth sensors that emit beams of light in a grid, a random dot array, or other pattern, and that have image sensors that generate depth maps based on the resulting spots of light produced on target objects), sensors that gather three-dimensional depth information using a pair of stereoscopic image sensors, lidar (light detection and ranging) sensors, proximity sensor components (e.g., light-based proximity sensors, capacitive proximity sensors, and/or proximity sensors based on other structures), visible light cameras, infrared cameras, capacitive sensors, strain gauges, ultrasonic sensors, and/or other sensors.

In some arrangements, nose tracking sensors may include one or more light sources such as infrared light-emitting diodes that emit infrared light to illuminate nose 90. Nose tracking sensor 16 may also include infrared cameras for capturing images of the user's nose and measuring reflections of infrared light from each of the infrared light sources. By processing these nose images, nose trackers 16 may track the location of nose 90, the topography of nose 90, and/or other features of nose 90 that can be used to determine when optical assemblies 20 are too close to the user's face. Nose tracking sensor 16 may sometimes be referred to as a nose tracking camera. The nose tracking camera may share one or more components (e.g., light emitters, light detectors, control circuitry, etc.) with gaze tracker 62. If desired, light from gaze tracker 62 may be repurposed or redirected to illuminate nose 90. This is merely illustrative, however. If desired, nose tracking sensors 16 may be entirely separate from gaze trackers 62 and/or may be formed from non-optical sensors such as capacitive sensors, strain gauges, and/or other sensors. Arrangements in which nose tracking sensors 16 are formed from image sensors (e.g., cameras) may sometimes be described herein as an illustrative example.

Nose tracking sensors 16 may be mounted inside or outside of lens barrel 38. In some arrangements, nose tracking sensors 16 may be mounted in and/or may operate through a light seal of device 10. In general, nose tracking sensors 16 may be mounted in any suitable location that allows sensors 16 to track the position and/or topography of nose 90.

Control circuitry 40C may use nose tracking sensor 16 to monitor the topography of nose 90 and/or to monitor the location of nose 90 relative to optical assemblies 20. If optical assemblies 20 are detected or predicted to be too close to nose 90 (e.g., when nose tracking sensors 16 detect a depressed or concave nose topography or a reduced distance between nose 90 and optical assemblies 20), control circuitry 40C may take suitable action. For example, control circuitry 40C may output an alert or notification to the user, may output instructions to the user to adjust head-mounted device 10, may prevent further movement of optical assemblies 20, may reverse a previous movement of optical assemblies 10, and/or may take other actions.

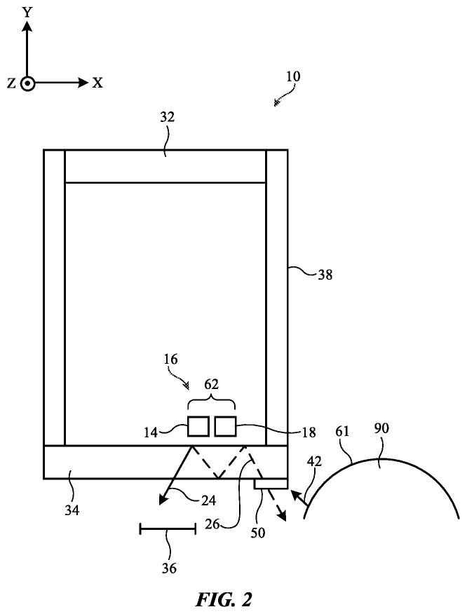

FIG. 2 illustrates an arrangement in which gaze tracking circuitry is used for nose tracking purposes. As shown in FIG. 2, optical module 20 may have lens barrel 38. Lens 34 may be used to provide an image from display 32 to eye box 36. To provide eye illumination that illuminates an eye that is located in eye box 36, gaze tracker 62 may contain one or more light sources (e.g., lasers, light-emitting diodes, lamps, etc.) such as light-emitting diodes 14. One or more cameras 18 may be included in each optical module 20 to monitor eye box 36. As shown in FIG. 2, for example, light-emitting diodes 14 of gaze tracker 62 may illuminate the user's eye with eye illumination 24 and may use camera 18 to capture images of the user's eye while the user's eye is located in eye box 36.

Light-emitting diodes 14 may emit light at one or more wavelengths of interest (e.g., visible light wavelengths and/or infrared light wavelengths, etc.) and camera 18 may be sensitive at these wavelengths (e.g., visible light wavelengths and/or infrared light wavelengths, etc.). In an illustrative configuration, light-emitting diodes 14 emit infrared light. Infrared light may be used to illuminate the user's eye in eye box 36 while being unnoticeable (or nearly unnoticeable) to the user (e.g., because human vision is not generally sensitive to infrared light except when the infrared light has an infrared wavelength near the edge of the visible light spectrum, which extends from 380 to 740 nm).

During operation, light from light-emitting diodes 14 may travel to eye box 36 through lens 34. Light-emitting diodes 14 are generally out of the user's field of view or nearly out of the user's field of view as the user is viewing images presented by display 32. Some of light-emitting diodes 14 (e.g., N light-emitting diodes 44, where N is at least 3, at least 4, at least 5, at least 6, 3-9, less than 15, less than 10, less than 7, less than 6, or other suitable number) may create reflections off of the surface of the user's eye in eye box 36. These reflections, which may sometimes be referred to as glints, can be captured by camera 18. Device 10 can process glint information obtained by cameras 18 to track the user's gaze. For example, control circuitry 40C can analyze the positions of the glints to determine the shape of the user's eye (e.g., the user's cornea). From this information, control circuitry 40C can determine the direction of the user's gaze.

In addition to serving as glint light sources (e.g., light sources that produce glint

illumination that is detected as discrete eye glints by camera 18), light from light-emitting diodes 14 may serve as nose illumination. In particular, light-emitting diodes 14 may emit nose illumination 26 that illuminates portions of nose 90 such as outer surfaces 61 of nose 90. Nose illumination 26 and eye illumination 24 may be produced by separate light-emitting diodes 14 or may be produced by the same light-emitting diodes 14 (at the same time or at different times). If desired, light-emitting diodes 14 may be a steerable array of light emitting diodes so that eye illumination 24 can be steered toward eye boxes 36 and nose illumination 26 can be steered toward nose 90 (or steered toward lens 34 such that light 26 enters lens 34 at an angle that causes light 26 to propagate within lens 34 in accordance with the principal of total internal reflection).

During operation, camera 18 can capture an image of nose 90 as nose 90 is being illuminated by light from diodes 14 (see reflected light 42 that is reflected from surface 61 of nose 90). The user's nose 90 will have a topographical surface that varies depending on the force being applied by device 10 (e.g., optical assemblies 20) on surfaces 61. If, as an example, optical assemblies 20 are at a first nonzero distance from nose 90, surface 61 may have a first surface topography (e.g., the user's natural skin topography) whereas if optical modules 20 are moved too closely toward nose 90, surface 61 may have a slightly depressed or concave surface topography relative to the natural unpressed state. By analyzing changes in the surface topography of side surfaces 61 of nose 90, control circuitry 40C can determine whether optical assemblies 20 are too close to nose 90.

Additionally or alternatively, control circuitry 40C may use nose tracker 16 (e.g., gaze tracker 62) to measure a location of nose 90 relative to optical assemblies 20. For example, control circuitry 40C may use time-of-flight flight measurement techniques or other measurement techniques to determine the distance between nose 90 and optical assemblies 20 by emitting light 26 and measuring reflected light 42 reflected from nose 90. By analyzing the distance between nose 90 and optical assemblies 20, control circuitry 40C can determine whether optical assemblies 20 are too close to nose 90.

In arrangements where nose tracking sensor 16 is formed from gaze tracker 62 within lens barrel 38, lens 34 may serve as a light guide that propagates light 26 along the X-direction toward nose 90. In particular, light-emitting diodes 14 may emit nose illumination 26 at a critical angle with respect to lens 34 such that nose illumination 26 is guided within lens 34 in accordance with the principal of total internal reflection. If desired, pits, bumps, ridges, or other light-extraction features may be formed lens 34 to extract light 26 out of the outer surface of lens 34 to illuminate nose 90. Additionally or alternatively, optical structures such as optical structures 50 (e.g., an output coupler and/or input coupler formed from a diffraction grating or other diffractive optical element, a lens, one or more mirrors or reflective elements, and/or other optical structures) may be used to couple light into or out of lens 34 and/or to direct light 26 to nose 90.

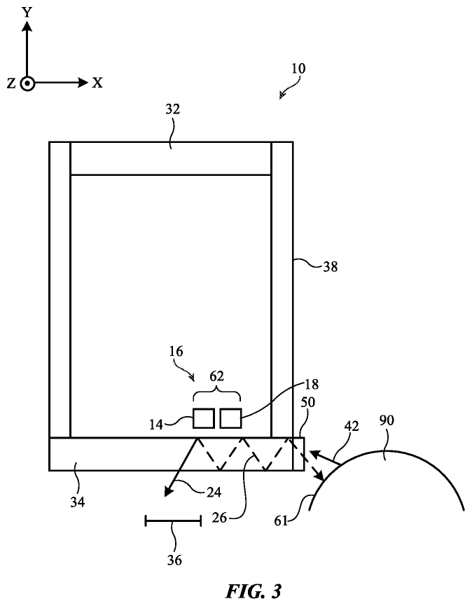

In the example of FIG. 2, nose illumination 26 is coupled out of the outer surface of lens 34, which is the same surface that eye illumination 24 is transmitted through to illuminate the user's eyes. This is merely illustrative. If desired, nose illumination 26 may be emitted out of a lateral edge surface of lens 34. This type of arrangement is illustrated in FIG. 3.

As shown in FIG. 3, lens 34 may serve as a light guide that propagates nose illumination 26 in the X-direction toward the edge surface of lens 34. Optical member 50 may include an output coupler to couple light 26 out of the edge surface of lens 34 and to direct light 26 toward nose 90, and/or optical member 50 may include an input coupler to couple reflected light 42 into lens 34 and to direct light 42 toward camera 18.

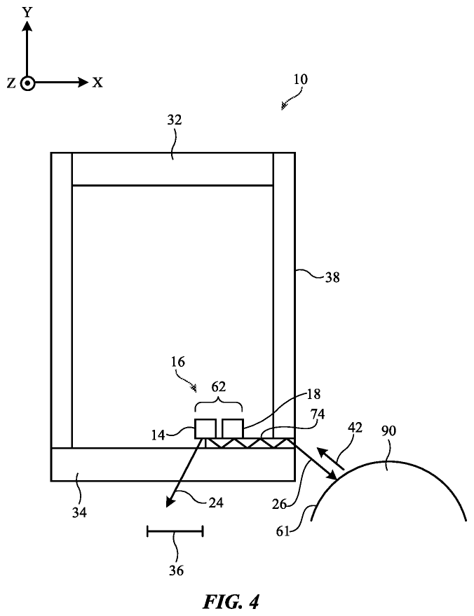

The example of FIGS. 2 and 3 in which lens 34 serves as a light guide for guiding nose illumination 26 to nose 90 and/or reflected nose illumination 42 toward camera 18 is merely illustrative. If desired, a dedicated light guide that is separate from lens 34 may be used to guide nose illumination to nose 90 and/or reflected illumination toward camera 18. This type of arrangement is illustrated in FIG. 4.

As shown in FIG. 4, a light guide such as light guide 74 may be used to guide nose illumination 26 from light-emitting diodes 14 of nose tracking sensor 16 (e.g., gaze tracker 62) along the X-direction toward nose 90. Nose illumination 26 may be guided within light guide 74 in accordance with the principal of total internal reflection. If desired, pits, bumps, ridges, or other light-extraction features may be formed light guide 74 to extract light 26 out of light guide 74 to illuminate nose 90. Optical structures such as an output coupler and/or input coupler (e.g., a diffraction grating or other diffractive optical element), a lens, one or more mirrors or reflective elements, and/or other optical structures may optionally be used to couple light into or out of light guide 74 and/or to direct light 26 to nose 90.

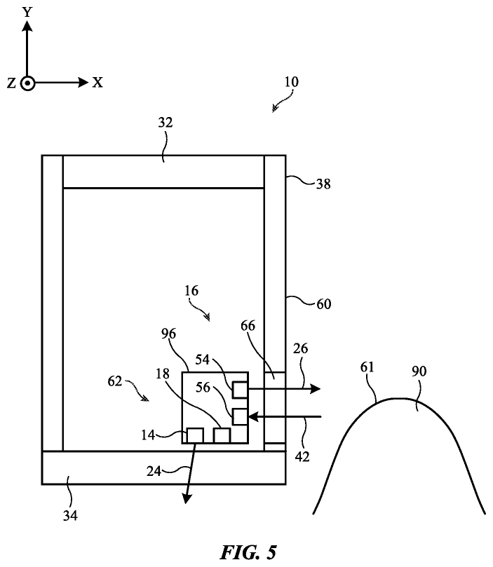

In some arrangements, device 10 may include dedicated gaze tracking sensors and nose tracking sensors that are integrated into a common module. This type of arrangement is illustrated in FIG. 5. As shown in FIG. 5, gaze tracking sensor 62 and nose tracking sensor 16 may be integrated together in module 96. Gaze tracking sensor 62 and nose tracking sensor 16 may share one or more components such as common control circuitry (e.g., storage and/or processing circuitry), a common substrate (e.g., a common printed circuit substrate), a common housing (e.g., a common packaging), and/or other shared structures. In the example of FIG. 5, module 96 includes gaze tracking components 14 and 18 (e.g., light-emitting diodes 14 and camera 18) and nose tracking components 54 and 56.

To provide nose illumination 26 that illuminates nose 90, nose tracking sensor 16 may contain one or more light sources (e.g., lasers, light-emitting diodes, lamps, etc.) such as light-emitting diodes 54. One or more cameras 56 may be included in each module 96 to monitor nose 90. As shown in FIG. 5, for example, light-emitting diodes 54 of nose tracker 16 may illuminate the user's nose 90 with nose illumination 26 and may use camera 56 to capture images of the user's nose 90 (see reflected nose illumination 42).

Light-emitting diodes 54 may emit light at one or more wavelengths of interest (e.g., visible light wavelengths and/or infrared light wavelengths, etc.) and camera 56 may be sensitive at these wavelengths (e.g., visible light wavelengths and/or infrared light wavelengths, etc.). In an illustrative configuration, light-emitting diodes 54 emit infrared light. Infrared light may be used to illuminate the user's nose 90 while being unnoticeable (or nearly unnoticeable) to the user.

During operation, light from light-emitting diodes 54 may travel to nose 90 through an opening such as opening 66 in lens barrel 38. Opening 66 may be an air-filled opening or may be filled with an optical coupling member (e.g., a lens, a transparent member, a diffraction grating or other diffractive optical element, etc.). During operation, camera 56 can capture an image of nose 90 as nose 90 is being illuminated by light 25 from diodes 54 (see reflected light 42 that is reflected from surface 61 of nose 90). The user's nose 90 will have a topographical surface that varies depending on the force being applied by device 10 (e.g., optical assemblies 20) on surfaces 61. By analyzing the three-dimensional surface topography of side surfaces 61 of nose 90, control circuitry 40C can determine whether optical assemblies 20 are too close to nose 90.

Additionally or alternatively, control circuitry 40C may use nose tracker 16 to measure a location of nose 90 relative to optical assemblies 20. For example, control circuitry 40C may use time-of-flight flight measurement techniques or other measurement techniques to determine the distance between nose 90 and optical assemblies 20 by emitting light 26 and measuring reflected light 42 reflected from nose 90. By analyzing the distance between nose 90 and optical assemblies 20, control circuitry 40C can determine whether optical assemblies 20 are too close to nose 90.

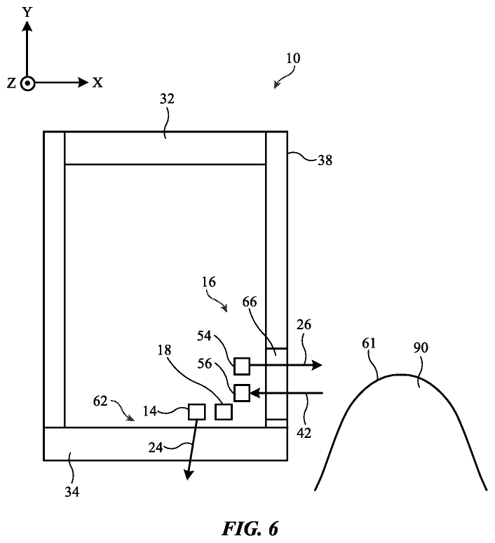

The example of FIG. 5 in which nose tracking sensor 16 and gaze tracking sensor 62 are formed within common module 96 is merely illustrative. If desired, each optical assembly 20 may include a dedicated nose tracking sensor and a dedicated gaze tracking sensor that are separate from one another (e.g., without sharing common components, housing, circuitry, etc.). This type of arrangement is illustrated in FIG. 6.

As shown in FIG. 6, gaze tracking sensor 62 and nose tracking sensor 16 may be mounted within lens barrel 38. Gaze tracking sensor 62 may include light-emitting diodes 14 for emitting eye illumination through lens 34 and may include camera 18 for detecting reflected eye illumination through lens 34. Nose tracking sensor 16 may include light-emitting diodes 54 for emitting nose illumination 26 through opening 66 and may include camera 56 for detecting reflected nose illumination 42 through opening 66.

If desired, nose tracking sensors 16 within left and right optical assemblies (e.g., mounted within lens barrels 38 as in the examples of FIGS. 2, 3, 4, 5, and 6) may be formed from other types of optical components (e.g., single light-emitting diodes instead of an array, lasers instead of light-emitting diodes, visible light cameras instead of infrared cameras, etc.) or may be formed from non-optical sensors such as capacitive sensors, ultrasonic sensors, strain gauges or other force sensors, and/or other sensors. The use of infrared light-emitting diodes and infrared cameras is merely illustrative.

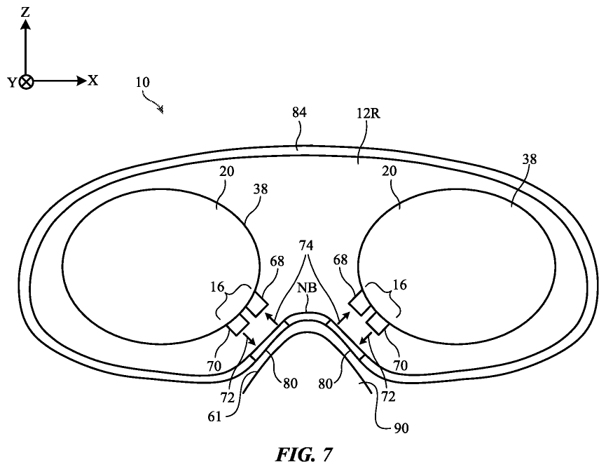

In addition to or instead of mounting nose tracking sensors 16 within lens barrels 38 of optical assemblies 20, one or more nose tracking sensors 16 may be mounted outside of optical assemblies 20. FIGS. 7, 8, and 9 show illustrative examples of head-mounted device 10 in which nose tracking sensors 16 are mounted outside of optical assemblies 20.

FIG. 7 is a rear view of device 10. As shown in FIG. 7, rear curtain 12R may have first and second openings that respectively receive first and second optical assemblies 20. Rear curtain 12R may be configured to stretch or otherwise move to accommodate movement of optical assemblies 20. A light seal such as light seal 84 may extend around the perimeter of rear curtain 12R and may block light from entering between device 10 and the user's face. Light seal 84 may include one or more layers of foam, polymer, fabric, and/or other materials.

Device 10 may include a nose-shaped recess such as nose bridge portion NB that is configured to receive nose 90. If desired, nose bridge portion NB may be formed from a portion of light seal 84 (e.g., light seal 84 may have a nose-shaped recess that forms nose bridge portion NB). Nose bridge portion NB may be formed from a stretchy fabric that receives nose 90 when device 10 is being worn on the user's head.

The distance between nose bridge portion NB and optical assemblies 20 may change as optical assemblies 20 are moved to accommodate different interpupillary distances. In some situations (e.g., when a user has a wide interpupillary distance), optical assemblies 20 reside at a non-zero distance from nose bridge portion NB after motors 48 adjust the positions of assemblies 20 to match the user's interpupillary distance. In other situations, such as when a user has a large eye relief and small interpupillary distance, motors 48 may move optical assemblies inward until curtain 12R of FIG. 1 and optical assemblies 20 reach the left and right sides of nose bridge portion NB. Since nose bridge portion NB rests on nose 90, nose tracking sensors 16 can monitor the gap between optical assemblies 20 and nose 90 by tracking the distance between nose bridge portion NB and optical assemblies 20.

In the example of FIG. 7, nose bridge portion NB includes surfaces 80 which rest on the user's nose 90. One or more nose tracking sensors 16 may be mounted to the exterior surface of each lens barrel 38 of optical assemblies 20 and may track the distance to surfaces 80. In particular, each nose tracking sensor 16 may include one or more light-emitting devices such as light-emitting diode 70 and one or more light sensors such as light sensor 68. Light-emitting diode 70 may emit light 72 toward surface 80. Surface 80 may be reflective (e.g., may be formed from metal threads in a layer of fabric that forms light seal 84, may be formed from a metal coating that is applied to light seal 84, and/or may be formed from other reflective structures). Light sensor 68 may be used to detect reflected light 74 that reflects from surface 80. Based on the emitted light 72 and reflected light 74, nose tracking sensor 16 may determine the distance between optical assemblies 20 and surfaces 80. If the distance is less than a given threshold, control circuitry 40C may determine that optical assemblies have moved too close to nose 90 and may take appropriate action.

If desired, nose tracking sensor 16 may be mounted to surface 80 of nose bridge portion NB and may instead be used to measure the distance to a reflective surface on optical assemblies 20. The example of FIG. 7 is merely illustrative.

The use of optical components to measure the distance between nose bridge portion NB and optical assemblies 20 is merely illustrative. If desired, capacitive sensors, ultrasonic sensors, strain gauges or other force sensors, and/or other sensors may be used to measure the distance between optical assemblies 20 and nose bridge portion NB of light seal 84.

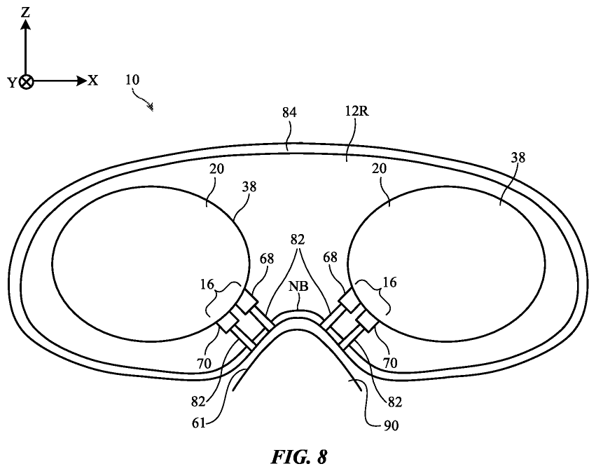

In the example of FIG. 8, nose tracking sensors 16 include light guides such as light guides 82. Light guides 82 may be used to guide light within curtain 12R and/or within light seal 84. For example, a first light guide 82 may be used to guide light from light-emitting diodes 70 to nose 90, while a second light guide 82 may be used to guide reflected light from nose 90 to light sensors 68. Nose tracking sensor 16 may be configured to track the distance between optical assemblies 20 and nose bridge portion NB (similar to the example of FIG. 7), or nose tracking sensors 16 may be used to track nose 90 itself (e.g., by illuminating nose 90 and capturing images of nose 90 through openings in light seal 84).

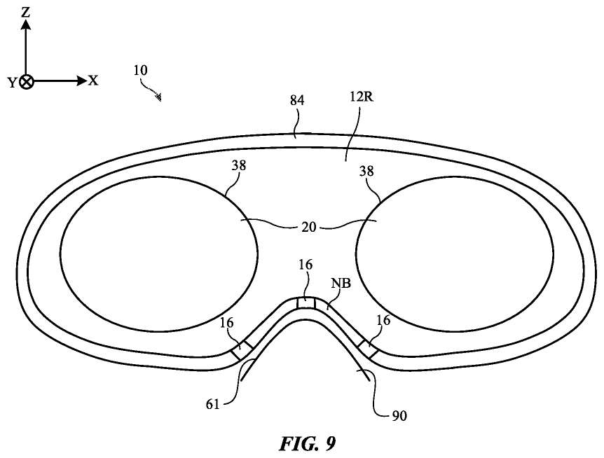

In the example of FIG. 9, nose tracking sensors 16 are mounted within light seal 84. Nose tracking sensors 16 may be mounted within nose bridge portion NB of light seal 84 or may be mounted in other portions of light seal 84. If desired, one or more openings may be formed in light seal 84 to allow nose illumination from nose tracking sensors 16 to reach nose 90 and/or for allowing reflected nose illumination to reach nose tracking sensors 16 from nose 90. Nose tracking sensors 16 may include light-emitting diodes and cameras that detect the location of nose 90 and/or that measure the three-dimensional surface topography of nose 90. Arrangements in which nose tracking sensors 16 are formed from non-optical components such as capacitive sensors, ultrasonic sensors, strain gauges or other forces sensors, and/or other sensors may also be used.

To help protect the privacy of users, any personal user information that is gathered by sensors may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A head-mounted device, comprising:
a head-mounted housing having a nose bridge portion configured to receive a nose;
left and right optical assemblies in the head-mounted housing that are configured to provide respective left and right images to left and right eye boxes, wherein the left and right optical assemblies are movable relative to one another; and
a nose tracking sensor configured to capture an image of at least a portion of the nose.

2. The head-mounted device defined in claim 1 wherein the left optical assembly comprises a lens barrel and a lens mounted in the lens barrel, and wherein the nose tracking sensor is located in the lens barrel.

3. The head-mounted device defined in claim 2 wherein the nose tracking sensor comprises light-emitting diodes configured to emit eye illumination for gaze tracking and nose illumination to capture the image.

4. The head-mounted device defined in claim 3 wherein the light-emitting diodes are configured to emit the eye illumination and the nose illumination through the lens.

5. The head-mounted device defined in claim 4 wherein the lens is configured to guide the nose illumination laterally out of the lens toward the nose.

6. The head-mounted device defined in claim 3 further comprising a light guide configured to guide the nose illumination out of the lens barrel toward the nose.

7. The head-mounted device defined in claim 2 further comprising a gaze tracking sensor located in the lens barrel.

8. The head-mounted device defined in claim 7 wherein the gaze tracking sensor and the nose tracking sensor are formed in a common module.

9. The head-mounted device defined in claim 7 wherein the gaze tracking sensor comprises a first set of light-emitting diodes that are configured to emit eye illumination through the lens and wherein the nose tracking sensor comprises a second set of light-emitting diodes that are configured to emit nose illumination through an opening in the lens barrel.

10. The head-mounted device defined in claim 1 wherein the nose tracking sensor comprises infrared light-emitting diodes configured to emit nose illumination and an infrared camera configured to detect reflected nose illumination from the nose to capture the image.

11. A head-mounted device, comprising:
a head-mounted housing having a nose bridge portion configured to receive a nose;
an optical assembly in the head-mounted housing that is configured to provide an image to an eye box, wherein the optical assembly comprises a lens barrel and a lens mounted in the lens barrel; and
a gaze tracking camera in the lens barrel configured to capture an image of at least a portion of the nose.

12. The head-mounted device defined in claim 11 wherein the gaze tracking sensor comprises light-emitting diodes configured to emit eye illumination and nose illumination.

13. The head-mounted device defined in claim 12 wherein the lens is configured to guide the nose illumination laterally out of the lens toward the nose.

14. The head-mounted device defined in claim 12 further comprising a light guide configured to guide the nose illumination out of the lens barrel toward the nose.

15. The head-mounted device defined in claim 14 wherein the lens barrel has an opening and wherein the nose illumination exits the lens barrel through the opening.

16. A head-mounted device, comprising:
a head-mounted housing;
a light seal coupled the head-mounted housing and comprising a nose bridge portion configured to receive a nose;
left and right optical assemblies in the head-mounted housing that are configured to provide respective left and right images to left and right eye boxes, wherein the left and right optical assemblies are movable relative to one another; and
and a nose tracking sensor in the head-mounted housing that gathers nose measurements through the nose bridge portion of the light seal.

17. The head-mounted device defined in claim 16 wherein the nose bridge portion of the light seal comprises a reflective surface and wherein the nose tracking sensor is configured to measure a distance between the reflective surface and the nose tracking sensor.

18. The head-mounted device defined in claim 16 further comprising a light guide coupled between the nose tracking sensor and the nose bridge portion of the light seal.

19. The head-mounted device defined in claim 18 wherein the nose tracking sensor comprises a light-emitting diode configured to emit nose illumination through the light guide. 20 The head-mounted device defined in claim 16 wherein the nose tracking sensor is mounted in the nose bridge portion of the light seal and is configured to gather the nose measurements by capturing nose images through the light seal.
